(19) United States
(12) Patent Application Publication
(10) Pub. No.: US 2017/0243150 A1
(43) Pub. Date: Aug. 24, 2017

(54) A METHOD AND SYSTEM FOR ANALYZING THE PERFORMANCE OF A COMPANY

(71) Applicant: Televisory Global Pte. Ltd., Singapore (SG)

(72) Inventor: Shiv Kumar DAVE, Jakarta (ID)

(73) Assignee: Televisory Global Pte. Ltd, Singapore (SG)

(21) Appl. No.: 15/503,835

(22) PCT Filed: Aug. 20, 2014
(86) PCT No.: PCT/SG2014/000393

§ 371 Date: Feb. 14, 2017

(51) Int. Cl. G06Q 10/06; G06Q 30/02; G06Q 40/00

(52) U.S. Cl. CPC G06Q 10/06393; G06Q 10/06395; G06Q 40/12; G06Q 30/0254

(57) ABSTRACT

A method for analyzing the performance of a company comprising providing predefined distinct industry types for selection; receiving the company's characteristics data comprising its selected distinct industry type (DIT) but not its identity; receiving its financial and operating data; and receiving selected filtering criteria. Then selecting peer records from a comparison database based on the filtering criteria, the peer record having the same DTT, selecting a global benchmark company record from the comparison database based on the global benchmark company record also having the same DTT. Then calculating the average financial and operating data of the selected peer records; performing a comparison between the financial and operating data of the company with the averaged data, and the corresponding data of the selected global benchmark company record. Then storing the characteristics data, financial and operating data of the company in a master database as a new peer record; and performing quality checks on the new peer record and storing the new peer record in the comparison database.

### FIELD OF THE INVENTION

The invention pertains to a method and system for analyzing and benchmarking the financial and operational performance of a company.

### BACKGROUND

Financial analytic services are well-established in the current state of the market place. Such services often come in the form of financial analysis solution software (product based model) and provision of financial information such as industry benchmarking reports and market intelligence on merger and acquisition deals (subscription based model). Other analytic solutions include risk management solutions and solutions on procurement, transfer pricing, credit and valuation. Benchmarking tools are useful because a company can compare itself against peers and therefore has some gauge as to the company's performance. Benchmarking tools typically compare the financial performance (e.g. revenue, profit and loss etc) between the company and its peers.

However, existing benchmarking tools do not factor or have very limited coverage on the operational performance of a company. The invention therefore fulfills this need by incorporating the operational performance with the financial performance of a company to provide a more comprehensive and robust depiction of its overall performance.

Further, existing benchmarking tools on financial information in the marketplace are catered largely to listed companies, while those for private companies are not readily available in the public domain as the information of private companies are inherently private. As such, there is a gap in performing a meaningful operational and financial performance comparison between companies in the private sphere and between companies in the private and public sphere.

### SUMMARY OF INVENTION

According to a first aspect of the invention, a method for analyzing the performance of a company is described, the method comprising the steps of providing a plurality of predefined distinct industry types for selection; receiving characteristics data of the company, the characteristics data comprising the selected distinct industry type of the company and not comprising the identity of the company; receiving financial data and operating data of the company; and receiving selected filtering criteria. The method further comprises the step of selecting a plurality of peer records from a comparison database, each peer record comprising characteristics data, financial data and operating data of another company, the characteristics data comprising the distinct industry type of the another company and not comprising the identity of the another company; wherein the selection of the plurality of peer records is based on the selected filtering criteria and based on the peer record having the same distinct industry type as the company. The method further comprises the step of selecting at least one global benchmark company record from the comparison database, the comparison database comprising a plurality of global benchmark company records, each global benchmark company record comprising characteristics data, financial data and operating data of a global benchmark company, the characteristics data comprising the distinct industry type of the global benchmark company and the identity of the global benchmark company; wherein the selection of the at least one global benchmark company record is based on the global benchmark company record having the same distinct industry type as the company. The method further comprises the steps of computing the average financial data and operating data of the plurality of the selected peer records; performing a comparison between the financial data and operating data of the company and the averaged financial data and operating data of the plurality of the selected peer records and performing a comparison between the financial data and operating data of the company and the financial data and operating data of the at least one selected global benchmark company record. The method further comprises the steps of storing the characteristics data, financial data and operating data of the company in a master database as a new peer record; and performing quality checks on the new peer record and storing the new peer record in the comparison database.

Preferably, the characteristics data of each of the plurality of selected peer records further comprises location of the another company, size of the another company, staff strength of the another company, and the number of subsidiaries and affiliates of the another company.

Preferably, the selected filtering criteria is any one or any combination of the following: location of the another company, size of the another company, and staff strength of the another company, and the number of subsidiaries and affiliates of the another company.

Preferably, the characteristics data of the at least one selected global benchmark company record further comprises location of the global benchmark company, size of the global benchmark company, staff strength of the global benchmark company, and the number of subsidiaries and affiliates of the global benchmark company.

Preferably, the method further comprises the step of providing input templates dependent on the distinct industry type of the company.

Preferably, the operating data of the company is dependent on the distinct industry type and comprises operational costs, amount of goods produced, amount of goods exported, inventory of goods, amount of raw material used in production, and amount of labor involved in the production.

Preferably, the step of performing a comparison between the financial data and operating data of the company and the averaged financial data and operating data of the plurality of the selected peer records comprises comparing financial data and operating data on a quarter on quarter basis or on a past four quarters and up to preceding five years basis.

Preferably, the step of performing a comparison between the financial data and operating data of the company and the financial data and operating data of the at least one selected global benchmark company record comprises comparing financial data and operating data on a quarter on quarter basis or on a past four quarters and up to preceding five years basis.

Preferably, the method further comprises the step of providing a message board system, wherein the message board system is configured to send to a user any one of the following: reports, targeted newsfeeds, targeted advertisements, targeted alerts and message alerts.

Preferably, the message alerts are sent by the message board system every quarter to prompt the user to update the financial data and operating data in the peer record.

According to a second aspect of the invention, a system for analyzing the performance of a company is described, the system comprising a master database, the master database comprising a plurality of company records; and a comparison database, the comparison database comprising a plurality of peer records and a plurality of global benchmark company records, each peer record comprising characteristics data, financial data and operating data of another company, the characteristics data comprising the distinct industry type of the another company and not comprising the identity of the another company, and each global benchmark company record comprising characteristics data, financial data and operating data of a global benchmark company, the characteristics data comprising the distinct industry type of the global benchmark company and the identity of the global benchmark company. The system further comprises a server having at least one processor programmed to provide a plurality of predefined distinct industry types for selection; receive characteristics data of the company, the characteristics data comprising the selected distinct industry type of the company and not comprising the identity of the company; receive financial data and operating data of the company and receive selected filtering criteria. The at least one processor is further programmed to select a plurality of peer records from the comparison database; wherein the selection of the plurality of peer records is based on the selected filtering criteria and based on the peer record having the same distinct industry type as the company; select at least one global benchmark company record from the comparison database; wherein the selection of the at least one global benchmark company record is based on the global benchmark company record having the same distinct industry type as the company; and compute the average financial data and operating data of the plurality of the selected peer records. The at least one processor is further programmed to perform a comparison between the financial data and operating data of the company and the averaged financial data and operating data of the plurality of the selected peer records; perform a comparison between the financial data and operating data of the company and the financial data and operating data of the at least one selected global benchmark company record; store the characteristics data, financial data and operating data of the company in the master database as a new peer record; and perform quality checks on the new peer record and store the new peer record in the comparison database.

Preferably, the characteristics data of each of the plurality of peer records further comprises location of the another company, size of the another company, staff strength of the another company, and the number of subsidiaries and affiliates of the another company.

Preferably, the selected filtering criteria is any one or any combination of the following: location of the another company, size of the another company, staff strength of the another company, and the number of subsidiaries and affiliates of the another company.

Preferably, the characteristics data of each of the plurality of global benchmark company records further comprises location of the global benchmark company, size of the global benchmark company, and staff strength of the global benchmark company, and the number of subsidiaries and affiliates of the global benchmark company.

Preferably, the at least one processor is further programmed to provide input templates dependent on the distinct industry type of the company.

Preferably, the operating data of the company is dependent on the distinct industry type and comprises operational costs, amount of goods produced, amount of goods exported, inventory of goods, amount of raw material used in production, and amount of labor involved in the production.

Preferably, the at least one processor is further programmed to perform a comparison between the financial data and operating data of the company and the averaged financial data and operating data of the plurality of the selected peer records on a quarter on quarter basis or on a past four quarters and up to preceding five years basis.

Preferably, the at least one processor is further programmed to perform a comparison between the financial data and operating data of the company and the financial data and operating data of the at least one selected global benchmark company record on a quarter on quarter basis or on a past four quarters and up to preceding five years basis.

Preferably, the at least one processor is further programmed to render a web portal.

Preferably, the at least one processor is further programmed to provide a message board system, wherein the message board system is configured to send to a user any one of the following: reports, targeted newsfeeds, targeted advertisements, targeted alerts and message alerts.

Preferably, the message alerts are sent by the message board system every quarter to prompt the user to update the financial data and operating data in the peer record.

The invention will now be described in detail with reference to the accompanying drawings.

### BRIEF DESCRIPTION OF THE DRAWINGS

The accompanying figures illustrate disclosed embodiment(s) and serve to explain principles of the disclosed embodiment(s). It is to be understood, however, that these drawings are presented for purposes of illustration only, and not for defining limits of the application.

FIG. 1 illustrates a system for analyzing the performance of a company in accordance with an exemplary embodiment of the present invention.

FIG. 2 illustrates an example of a distinct industry type.

FIG. 3 illustrates a method for analyzing the performance of a company in accordance with an exemplary embodiment of the present invention.

FIG. 4 illustrates an example of a peer comparison and a global benchmark company comparison between the operating data of a company and the operating data of an averaged peer and a global benchmark company.

FIG. 5 illustrates an example of a peer comparison and a global benchmark company comparison between the financial data of a company and the financial data of an averaged peer and a global benchmark company.

FIG. 6 illustrates an example of a peer comparison and a global benchmark company comparison between the operating data of a company and the operating data of an averaged peer and a global benchmark company.

FIG. 7 illustrates an example of a peer comparison and a global benchmark company comparison between the financial data of a company and the financial data of an averaged peer and a global benchmark company.

FIG. 8 illustrates an example of a peer comparison and a global benchmark company comparison between the financial data of a company and the financial data of an averaged peer and a global benchmark company.

FIG. 9 illustrates an example of a peer comparison and a global benchmark company comparison between the financial data of a company and the financial data of an averaged peer and a global benchmark company.

FIG. 10 illustrates an example of a peer comparison and a global benchmark company comparison between the operating data of a company and the operating data of an averaged peer and a global benchmark company on a past four quarters and preceding three years basis.

FIG. 11 illustrates an example of a peer comparison and a global benchmark company comparison between the operating data of a company and the operating data of an averaged peer and a global benchmark company on a past four quarters and preceding five years basis.

FIG. 12 illustrates an example of a peer comparison and a global benchmark company comparison between the financial data of a company and the financial data of an averaged peer and a global benchmark company on a past four quarters and preceding five years basis.

FIG. 13 illustrates an example of a peer comparison and a global benchmark company comparison between the financial data of a company and the financial data of an averaged peer and a global benchmark company on a past four quarters and preceding five years basis.

FIG. 14 illustrates an example of a peer comparison and a global benchmark company comparison between the financial data of a company and the financial data of an averaged peer and a global benchmark company on a past four quarters and preceding five years basis.

FIG. 15 illustrates the information flow between the message board system and the users.

Exemplary, non-limiting embodiments of the present application will now be described with references to the above-mentioned figures.

### DETAILED DESCRIPTION

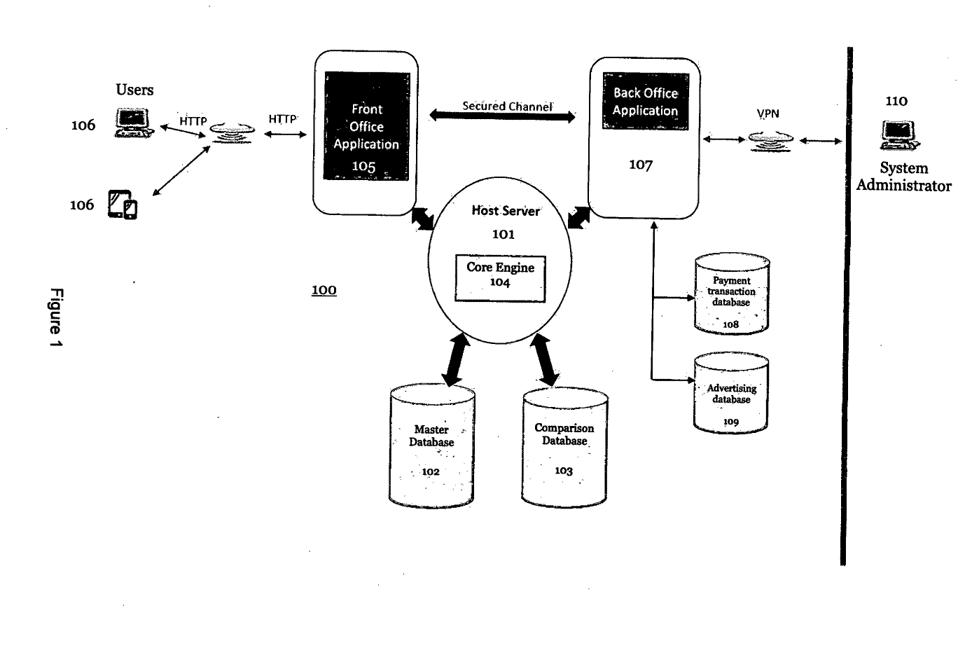

FIG. 1 illustrates system architecture 100 for analyzing the financial and operational performance of a company in accordance with an exemplary embodiment of the present invention. System architecture 100 comprises host server 101 communicatively connected to master database 102 and comparison database 103. Host server 101 has core engine 104. Core engine 104 can be a processor or a plurality of processors. Core engine 104 can implement front office application 105 in the form of a web portal. Users 106 can access the web portal via the interne using computer devices.

Core engine 104 can implement back office application 107 which has access to payment transaction database 108 and advertising database 109. System administrators 110 can access back office application 107 via a Virtual Private Network (VPN).

Master database 102 contains records of companies. These companies can include user companies and Global Benchmark Companies (GBCs). User companies can be private companies or public companies. The company records for user companies are peer records. Each peer record contains the characteristics data, the financial data and operating data of the user company. GBCs are companies that are recognized as leaders or frontrunners in their respective industries. The company records for GBCs are GBC records. Each GBC record contains the characteristics data, the financial data and operating data of the company.

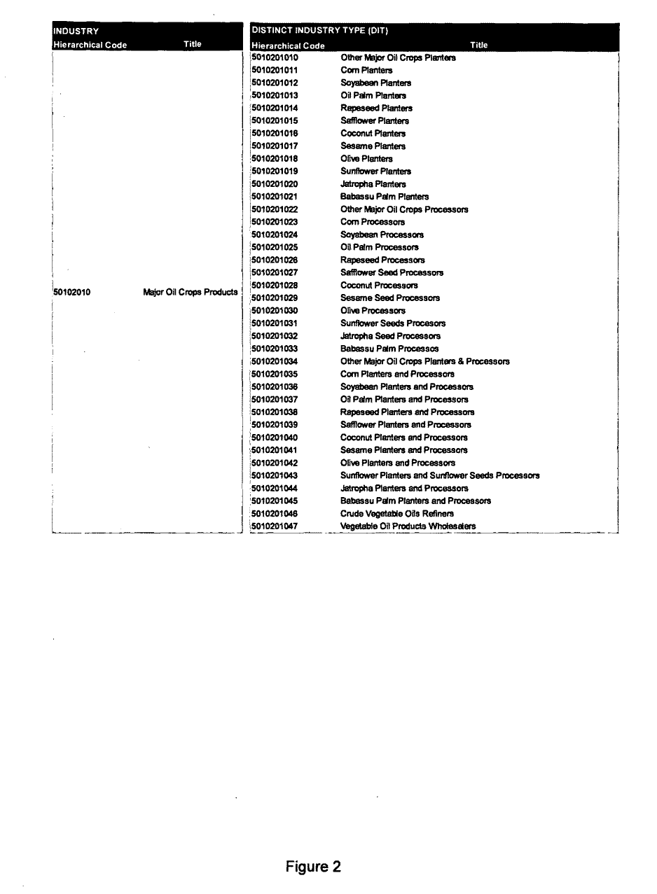

Throughout this specification, characteristics data means any data that pertains to the characteristics of a company. Characteristics data can non-exhaustively include distinct industry type (DIT), number of subsidiaries and affiliates, staff strength, listing status and location of operation. DIT is a classification system that defines the industry of the company. DIT can have a main class with sub classes to further specify the industry of the company. FIG. 2 shows an example of a DIT. Referring to FIG. 2, the main class of the DIT is Oil Crops Products Industry Group and the sub classes of the DIT are “corn planters”, “soyabean planters”, “oil palm planters” etc. Having a DIT classification system is important to the workings of the invention as companies in different industries will have distinct input requirements for operating data (which is explained later). For example, a mining company will have different operating parameters versus, say, an oil crop farmer.

One important feature is that the identity or name of the user company is absent in the peer records. This is to ensure anonymity of the information provided by the user companies. This is in contrast to GBCs where since the information is already public information anyway, therefore the GBC records include the identities of the GBCs.

Throughout this specification, financial data means any data that pertains to the financial performance of a company. Financial data can non-exhaustively include revenues, cost of production, depreciation, operating expenses, gross profit, administration expenses, operating profit, profit, and any data found in profit and loss statements, balance sheets and cash flow statements.

Throughout this specification, operating data means any data that pertains to the operations of a company. The operating data of the company comprises operational costs, amount of goods produced, amount of goods exported, inventory of goods, amount of major raw materials used in production, amount of labor involved in the production, and other relevant operational parameters distinct to the industry type. For example, if it is a mining company, operating data would non-exhaustively include the operational costs (e.g. mining costs, overburden removal costs, transportation costs of mineral and overburden, etc), amount of minerals produced, the amount of minerals exported, the inventory of minerals, the mineable reserves, the strip ratio achieved etc (strip ratio refers to the ratio of the tonnes of waste material required to be removed in order to extract one tonne of ore), overburden removed, transportation distance by road and river transportation.

The company records in master database 102 will undergo quality checks. Such quality checks may include data integrity checks to detect erroneous financial data, for example, when net income is higher than revenue. Once the company records have undergone quality checks, the company records would be copied and stored into comparison database 103. The quality checks are built in check-points and comparison database 103 is deliberately maintained separately from master database 102 to ensure data quality. Once there is a new company record entered into master database 102, the new company record will undergo quality checks and will then be added into comparison database 103.

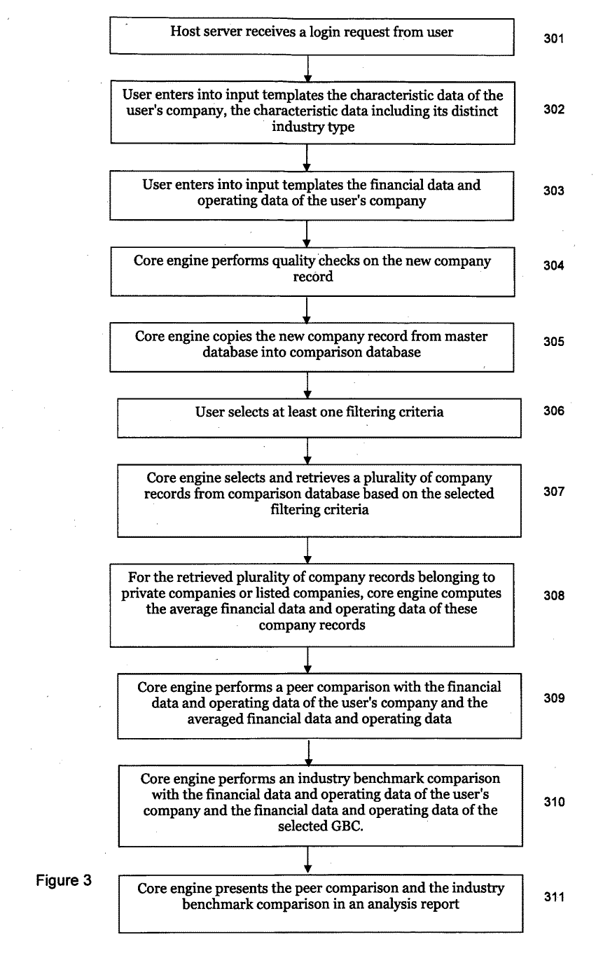

FIG. 3 illustrates a method for analyzing the performance of a company in accordance with an exemplary embodiment of the present invention. In step 301, host server receives a service request from user 106. User 106 intends to use the web portal to analyze the performance of a company (henceforth known as the user's company).

If user 106 is an existing user, core engine 104 retrieves the characteristics data of the user's company from comparison database 103. User 106 will have the ability to modify data or add data (be it characteristics data, financial data or operating data) for any new quarter or for the year-end using input templates.

If user 106 is a new user, the web portal presents an interface to user 106, the interface comprising input templates, allowing user 106 to enter the characteristics data of the user's company. In step 302, user 106 enters into the input templates the characteristics data of the user's company, the characteristics data including the distinct industry type (DIT). The input templates may present a menu with predefined DITs, allowing user 106 to select the main class and sub class of the DIT which describes the user's company's industry. Once user 106 has entered the characteristics data of the user's company, the characteristics data will be saved into master database 102, and user 106 will be assigned a unique identification number. One important feature is that user 106 does not need to disclose the identity of the user's company. This is to ensure anonymity of the user's company's data.

In step 303, user 106 enters into input templates the financial data and operating data of the user's company. Once user 106 has entered the financial data and operating data of the user's company, the financial data and operating data will be saved into master database 102. The input templates provided to user 106 would be dependent on the DIT chosen by user 106. This is because companies in different industries will have different operating data, and therefore would require specific input templates tailored to that particular industry. Alternatively, user 106 can download input templates, fill in the data offline, and then upload the completed input templates on to the web portal.

As a result of steps 302 and 303, a new peer record with the user's company's characteristics data, financial data and operating data will be saved into master database 102. In step 304, core engine 104 performs quality checks on the new peer record's data. An alert can be generated if the new peer record fails the quality check such that any erroneous data can be rectified or clarified with user 106.

If the new peer record passes the quality checks, in step 305, core engine 104 copies the new peer record from master database 102 into comparison database 103. In doing so, the user's company is able to act as a peer comparison for other users 106.

In step 306, user 106 selects at least one filtering criteria. Preferably, the filtering criteria is the location of the company. Preferably, the filtering criteria is the size of the company. The size of the company can refer to the size of production, or size of assets, or size of profitability or size of revenue. Preferably, the filtering criteria is the staff strength of the company. Preferably, the filtering criteria is the number of subsidiaries and affiliates of the company. Preferably, multiple filtering criteria can be used at any one time. The filtering criteria allow user 106 to specify the key characteristics data the selected companies should possess. For example, if user 106 is a coal miner based in in Kalimantan, Indonesia, having a staff strength of 500, and wants to be compared against a similarly sized coal miner (peer) in Kalimantan, Sumatera or in Australia, China, Mongolia, India, South Africa or Columbia, user 106 would also select the filtering criteria to be “location”, specifying Kalimantan, Sumatera or in Australia, China, Mongolia, India, South Africa or Columbia. User 106 may also select the filtering criteria to be “staff strength”, specifying 500.

Preferably, the filtering criteria is the identity of the GBC. User 106 may want to choose specific GBCs that are already familiar to him or those that he regards as industry benchmarks. Re-using the coal miner in Kalimantan, Indonesia example, user 106 can choose to be compared to GBCs Peabody, Coal India, China Coal or China Shenhua.

In step 307, core engine 104 selects and retrieves a plurality of peer records from comparison database 103 based on the selected filtering criteria. Core engine 104 also selects and retrieves at least one GBC record. Preferably, the DIT of the selected plurality of peer records is identical to the DIT of the user's company. Preferably, the DIT of the selected at least one GBC record is identical to the DIT of the user's company.

In step 308, core engine 104 computes the average financial data and operating data of the plurality of selected peer records. This averaged financial data and operating data will be used for the peer comparison. The advantage of using averaged financial data and operating data of a plurality of peer records is that it provides a more accurate depiction of the financial data and operating data of the peers, as opposed to data from a single peer which may be distorted and inaccurate.

In step 309, core engine 104 performs a peer comparison with the financial data and operating data of the user's company and the averaged financial data and operating data. The period of the peer comparison can be on a quarter on quarter basis or on a past four quarters and up to preceding five years basis.

In step 310, core engine 104 performs a GBC comparison with the financial data and operating data of the user's company and the financial data and operating data of the selected GBC record. The period of the GBC comparison can be on a quarter on quarter basis or on a past four quarters and up to preceding five years basis.

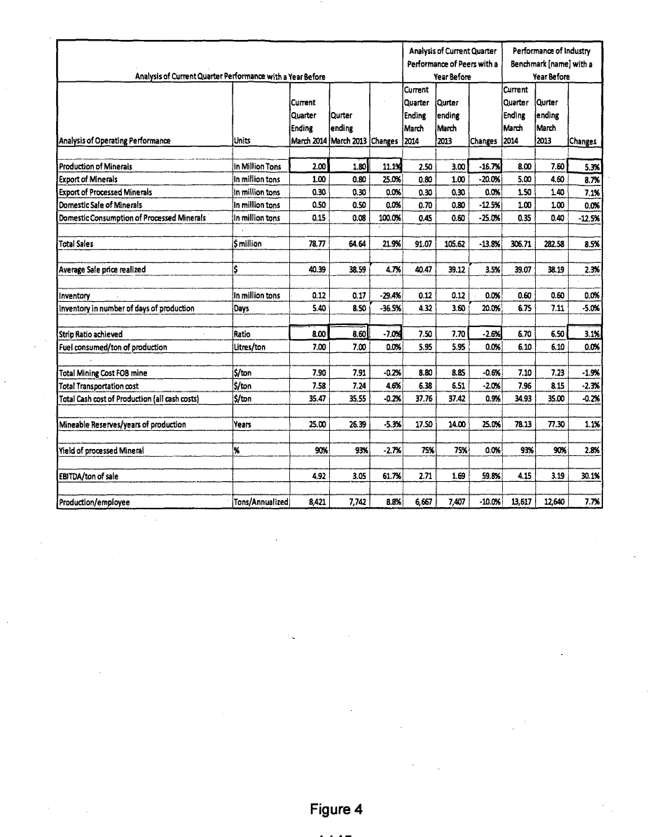

In step 311, core engine 104 presents the peer comparison and the GBC comparison in an analysis report. An exemplary illustration of the analysis report is shown in FIG. 4.

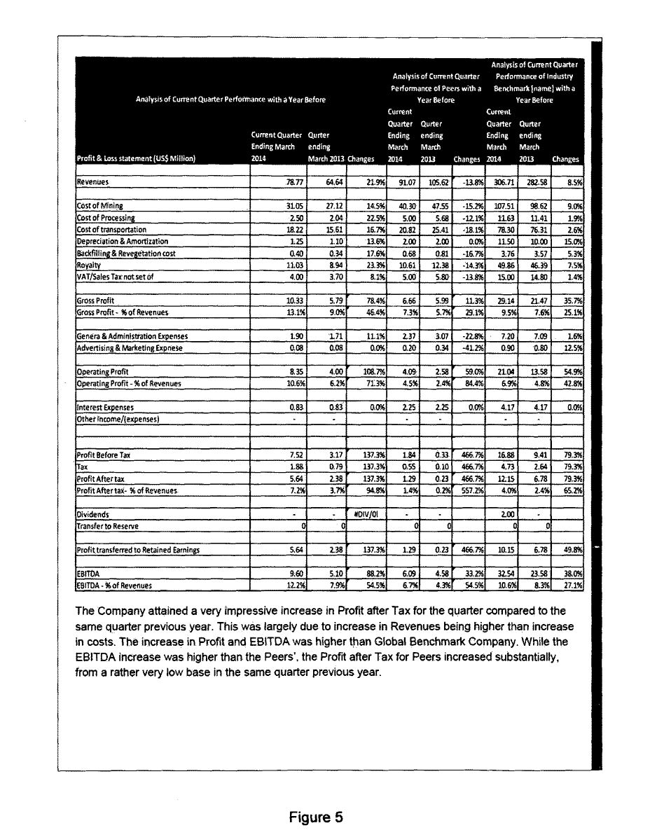

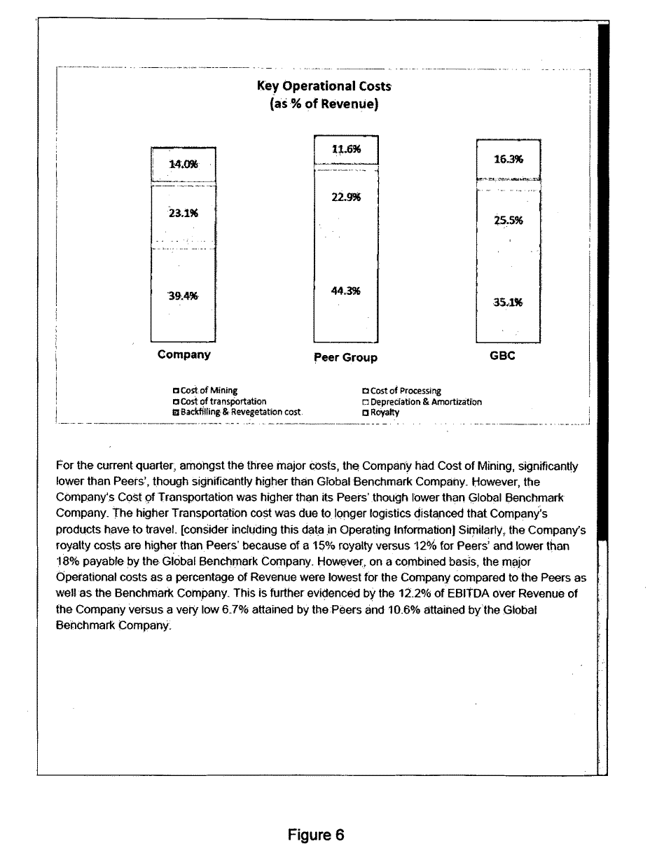

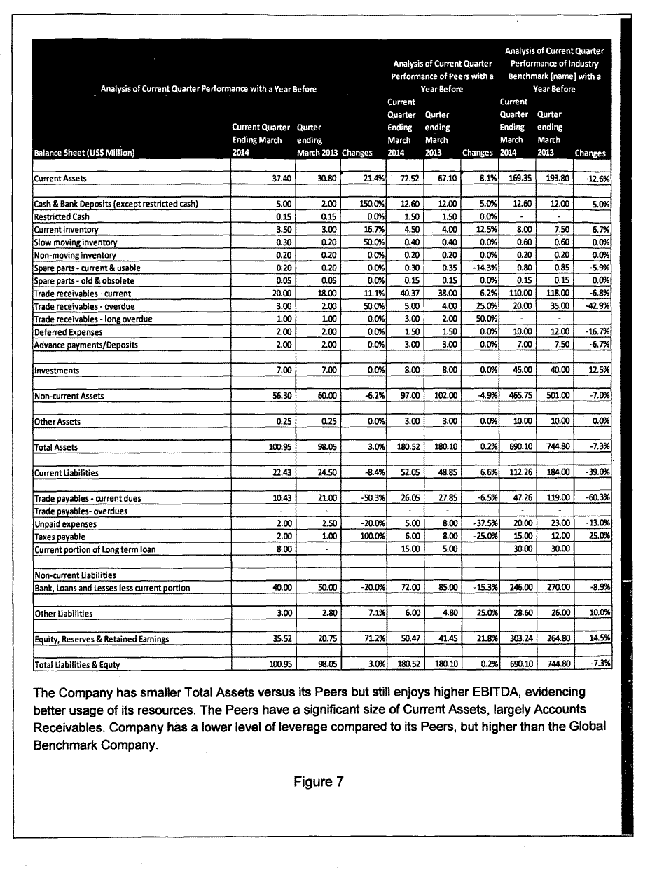

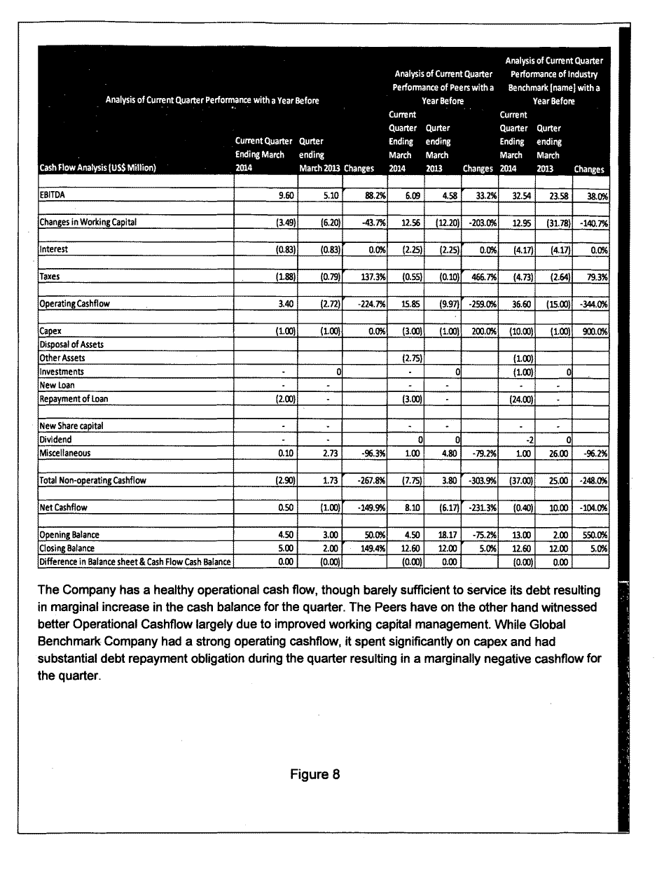

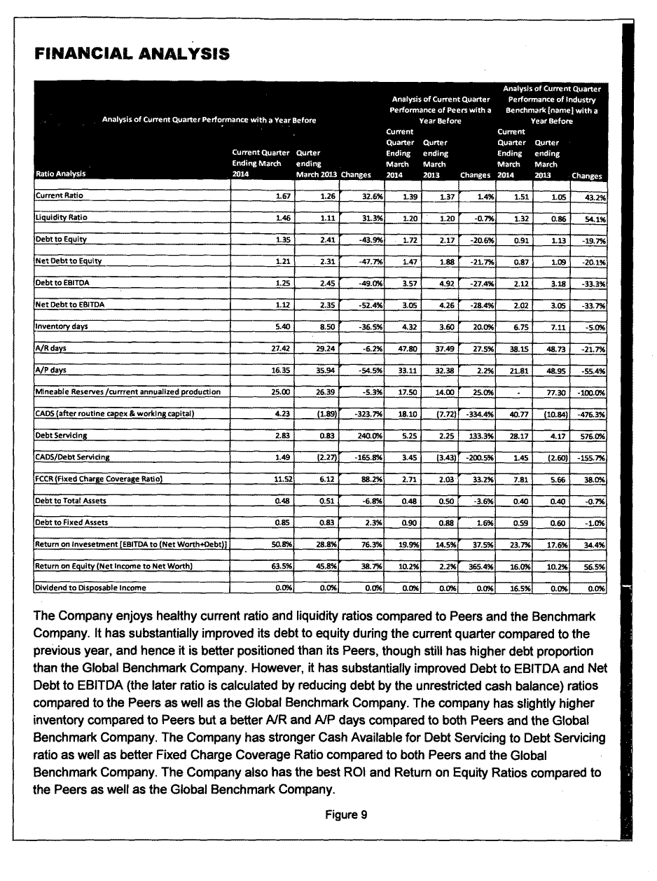

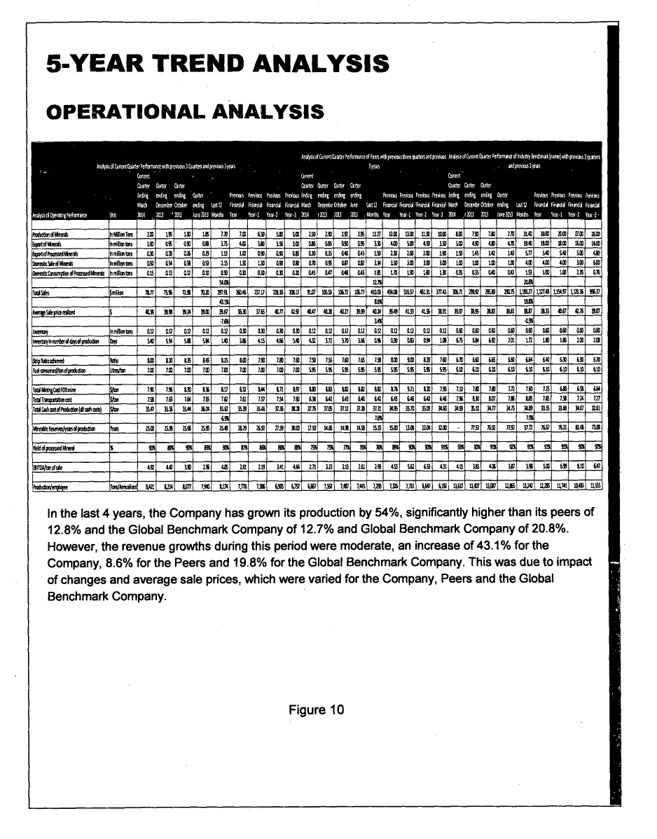

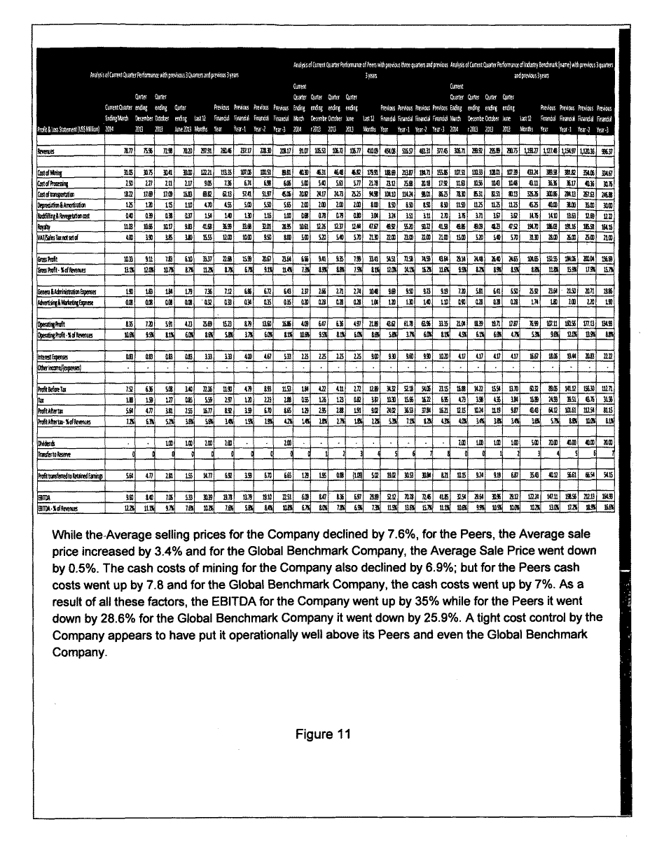

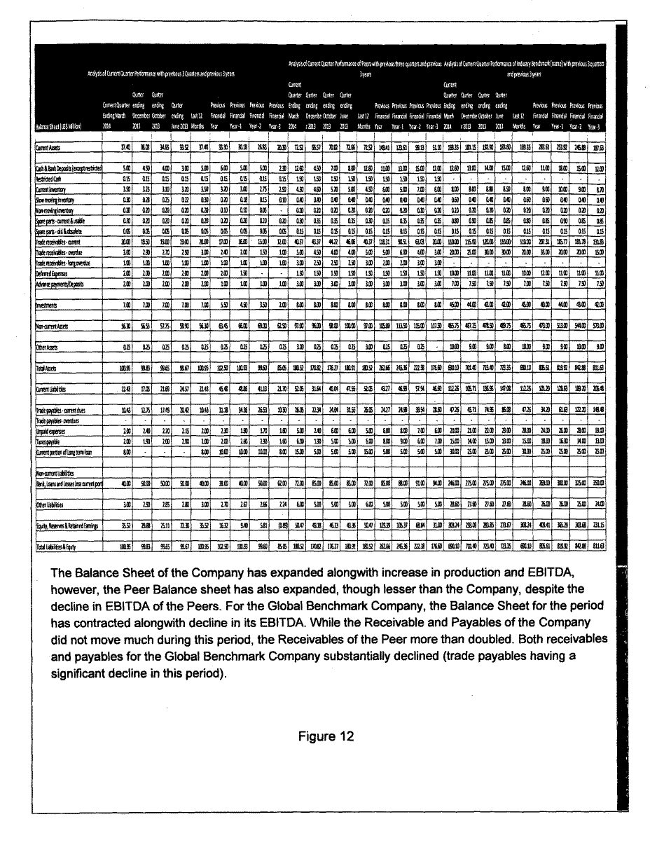

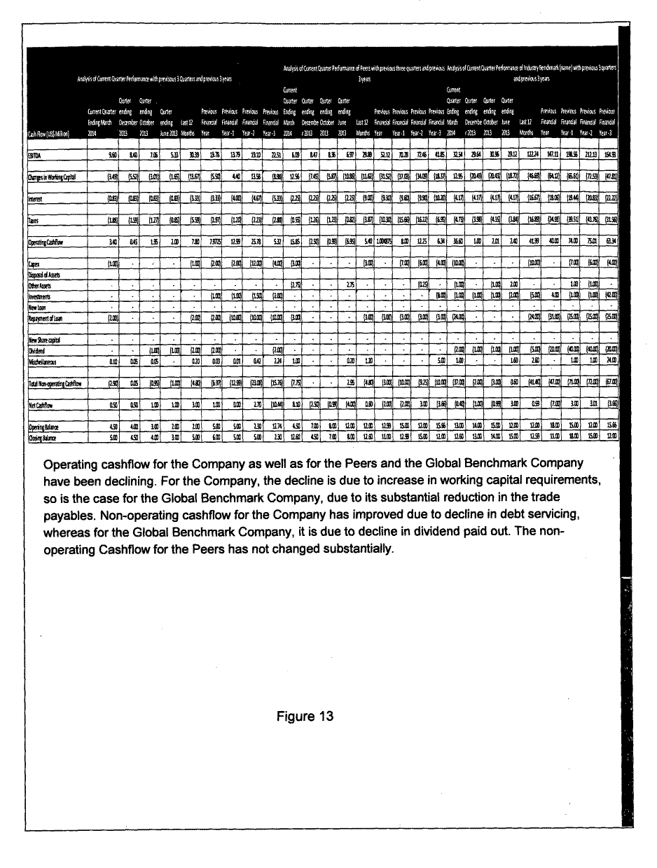

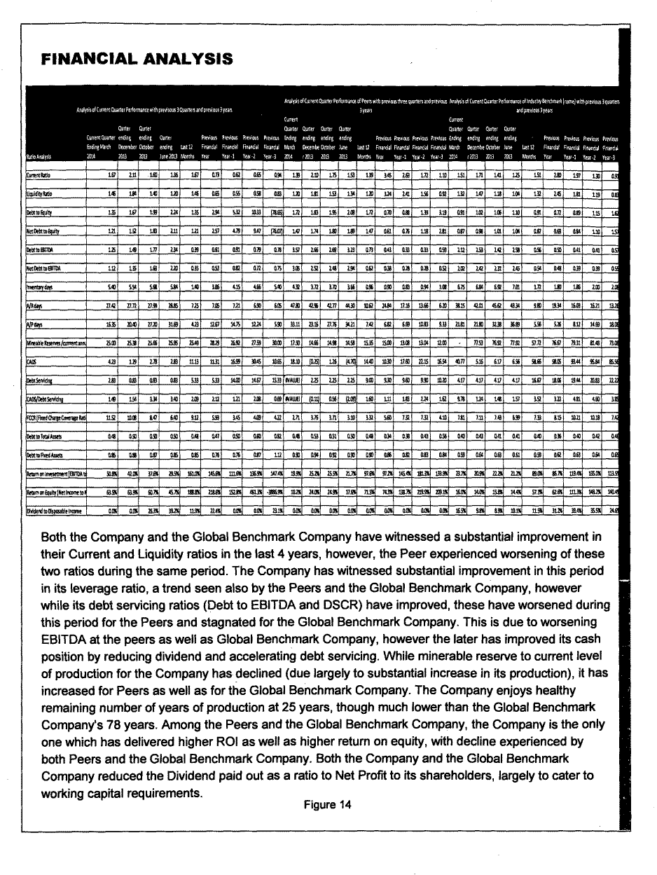

FIG. 4 depicts a peer comparison and a GBC comparison between the operating data of the user's company and the operating data of an averaged peer and a GBC. Referring to FIG. 4, the amount of production of materials for “Current Quarter Ending March 2014” for the user's company is 2.00 million tons. There is therefore a 11.1% increase in production from “Quarter ending March 2013” in which the user's company produced 1.80 million tons. In comparison, the averaged peer had a −16.7% drop in production while the GBC had a 5.3% increase in production. Therefore, it is apparent that the user's company performed better than the GBC. Perhaps more importantly, it is apparent that the user's company performed significantly better than the averaged peer. So what contributed to the user's company outstanding performance? A closer look at the operating data of the user's company indicates that the user's company had a strip ratio of 8.00 for “Current Quarter Ending March 2014” and a strip ratio of 8.60 for “Quarter ending March 2013”. There is therefore a −7.0% decrease in the strip ratio for the user's company. A lower strip ratio is desirable as it means that there is less waste material for every extracted volume of ore. The user's company therefore achieved a strong increase in EBITDA (a company's earnings before interest, taxes, depreciation, and amortization) due to a cut down in cost of mining, achieved largely due to the lower strip ratio. The −7.0% decrease in the strip ratio for the user's company also outperforms the strip ratio attained by the averaged peer (−2.6%) and the GBC (3.1%). One can thus appreciate that analyzing the operating data of a company is beneficial as one is able to determine the factors that attributed to the overall performance of the company. FIGS. 5 to 14 depict other examples of peer comparisons and GBC comparisons.

An important feature of the invention, as mentioned in step 305, is that after the user's company's characteristics data, financial data and operating data have been copied from master database 102 into comparison database 103 as a new peer record, the new peer record would act as a peer comparison for other users 106. In other words, user 106 who have used the web portal and have supplied data, would in turn participate as a peer as the supplied data would be used in subsequent peer comparisons for other users 106. Private companies would normally be unwilling to allow their operating data and financial data to be used in such a manner. However, as the identity of the private companies in the peer records are not disclosed, there is anonymity in the operating data and financial data, which would address the privacy concerns of these private companies. Comparison database 103 is therefore able to grow and accumulate peer records in this manner.

It is envisaged that core engine 104 would also send prompts to users 106 every quarter to login to the web portal and update their financial data and operating data. This is to ensure that the data in the peer records of comparison database 103 is up to date.

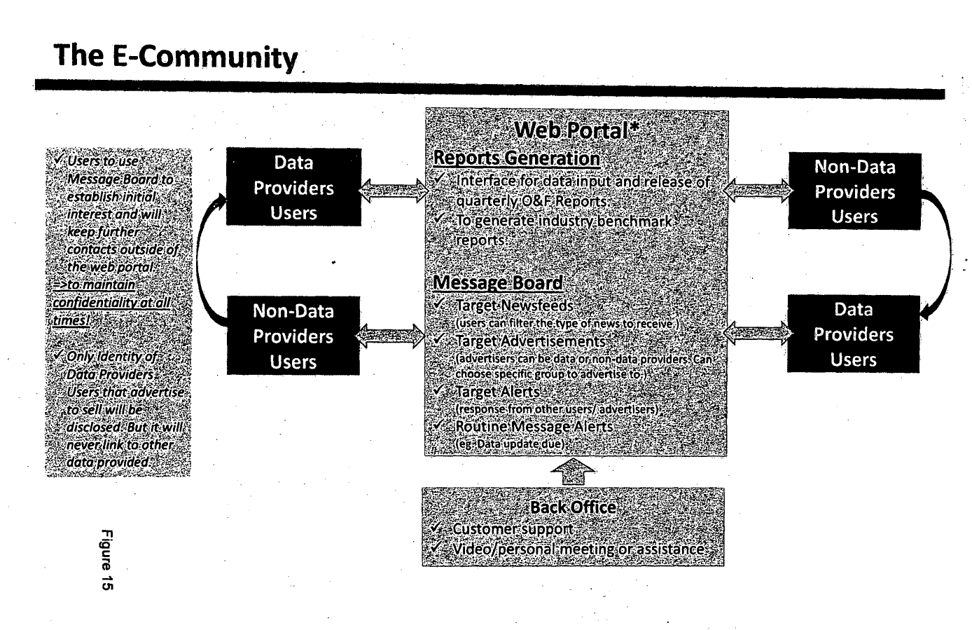

As more and more users 106 use system architecture 100 to generate the analysis reports, the community of users 106 will continue to grow, thus forming a network of users 106. The web portal provides mechanisms for users 106 to interact with one another. An example of such a mechanism is a message board system. Message board system is a mechanism to provide analysis reports to users 106 (given that the system does not retain any identity of the users 106) and for other users 106 to query on the data provided by them and send them targeted advertisements (which may include e-commerce requests). User 106 can then choose to take it off-line and respond to such advertisers outside the web portal to perhaps discuss potential business dealings like purchase or sale of outputs, purchase or sale of equipment or services. As the identities of users 106 are not disclosed, there is complete anonymity between users 106 when communicating with the message board system. FIG. 15 depicts the information flow between the message board system and users 106.

It is also possible that non-data provider users will access the web portal. Such non-data provider users include lenders and investors, who may simply wish to look for various DIT benchmark data that provide detailed financial and operational performance comparison data against their existing borrowers or investees. These lenders and investors may also wish to look for potential quality target companies to lend or invest in. The message board system also provides a medium for non-data provider users to communicate with users 106. The message board system allows the non-data provider users to send targeted newsfeeds, targeted advertisements, targeted alerts and routine message alerts to users 106. This is achieved by allowing the non-data provider users to filter or specify the targeted users 106. This could be part of the service package to be offered to non-data provider users.

Host server 101, master database 102 and comparison database 103 can be in one single machine. Alternatively, host server 101, master database 102 and comparison database 103 can be in different machines. One skilled in the art will appreciate that other variations are possible.

In the application, unless specified otherwise, the terms “comprising”, “comprise”, and grammatical variants thereof, intended to represent “open” or “inclusive” language such that they include recited elements but also permit inclusion of additional, non-explicitly recited elements.

It will be apparent that various other modifications and adaptations of the application will be apparent to the person skilled in the art after reading the foregoing disclosure without departing from the spirit and scope of the application and it is intended that all such modifications and adaptations come within the scope of the appended claims.

1. A method for analyzing the performance of a company comprising the steps of:
providing a plurality of predefined distinct industry types for selection;
receiving characteristics data of the company, the characteristics data comprising the selected distinct industry type of the company and not comprising the identity of the company;
receiving financial data and operating data of the company;
receiving selected filtering criteria;
selecting a plurality of peer records from a comparison database, each peer record comprising characteristics data, financial data and operating data of another company, the characteristics data comprising the distinct industry type of the another company and not comprising the identity of the another company; wherein the selection of the plurality of peer records is based on the selected filtering criteria and based on the peer record having the same distinct industry type as the company;
selecting at least one global benchmark company record from the comparison database, the comparison database comprising a plurality of global benchmark company records, each global benchmark company record comprising characteristics data, financial data and operating data of a global benchmark company, the characteristics data comprising the distinct industry type of the global benchmark company and the identity of the global benchmark company;
wherein the selection of the at least one global benchmark company record is based on the global benchmark company record having the same distinct industry type as the company;
computing the average financial data and operating data of the plurality of the selected peer records;
performing a comparison between the financial data and operating data of the company and the averaged financial data and operating data of the plurality of the selected peer records;
performing a comparison between the financial data and operating data of the company and the financial data and operating data of the at least one selected global benchmark company record;
storing the characteristics data, financial data and operating data of the company in a master database as a new peer record; and
performing quality checks on the new peer record and storing the new peer record in the comparison database.

2. The method of claim 1 wherein the characteristics data of each of the plurality of selected peer records further comprises location of the another company, size of the another company, staff strength of the another company, and the number of subsidiaries and affiliates of the another company.

3. The method of claim 1 wherein the selected filtering criteria is any one or any combination of the following: location of the another company, size of the another company, staff strength of the another company, and the number of subsidiaries and affiliates of the another company.

4. The method of claim 1 wherein the characteristics data of the at least one selected global benchmark company record further comprises location of the global benchmark company, size of the global benchmark company, staff strength of the global benchmark company, and the number of subsidiaries and affiliates of the global benchmark company.

5. The method of claim 1 further comprising the step of providing input templates dependent on the distinct industry type of the company.

6. The method of claim 1 wherein the operating data of the company is dependent on the distinct industry type and comprises operational costs, amount of goods produced, amount of goods exported, inventory of goods, amount of raw material used in production, and amount of labor involved in the production.

7. The method of claim 1 wherein the step of performing a comparison between the financial data and operating data of the company and the averaged financial data and operating data of the plurality of the selected peer records comprises comparing financial data and operating data on a quarter on quarter basis or on a past four quarters and up to preceding five years basis.

8. The method of claim 1 wherein the step of performing a comparison between the financial data and operating data of the company and the financial data and operating data of the at least one selected global benchmark company record comprises comparing financial data and operating data on a quarter on quarter basis or on a past four quarters and up to preceding five years basis.

9. The method of claim 1 further comprising the step of providing a message board system, wherein the message board system is configured to send to a user any one of the following: reports, targeted newsfeeds, targeted advertisements, targeted alerts and message alerts.

10. The method of claim 9 wherein the message alerts are sent by the message board system every quarter to prompt the user to update the financial data and operating data in the peer record.

11. A system for analyzing the performance of a company comprising:
a master database, the master database comprising a plurality of company records;
a comparison database, the comparison database comprising a plurality of peer records and a plurality of global benchmark company records, each peer record comprising characteristics data, financial data and operating data of another company, the characteristics data comprising the distinct industry type of the another company and not comprising the identity of the another company, and each global benchmark company record comprising characteristics data, financial data and operating data of a global benchmark company, the characteristics data comprising the distinct industry type of the global benchmark company and the identity of the global benchmark company;
a server having at least one processor programmed to:
provide a plurality of predefined distinct industry types for selection;
receive characteristics data of the company, the characteristics data comprising the selected distinct industry type of the company and not comprising the identity of the company;
receive financial data and operating data of the company;
receive selected filtering criteria;
select a plurality of peer records from the comparison database; wherein the selection of the plurality of peer records is based on the selected filtering criteria and based on the peer record having the same distinct industry type as the company;
select at least one global benchmark company record from the comparison database; wherein the selection of the at least one global benchmark company record is based on the global benchmark company record having the same distinct industry type as the company;
compute the average financial data and operating data of the plurality of the selected peer records;
perform a comparison between the financial data and operating data of the company and the averaged financial data and operating data of the plurality of the selected peer records;
perform a comparison between the financial data and operating data of the company and the financial data and operating data of the at least one selected global benchmark company record;
store the characteristics data, financial data and operating data of the company in the master database as a new peer record; and
perform quality checks on the new peer record and store the new peer record in the comparison database.

12. The system of claim 11 wherein the characteristics data of each of the plurality of peer records further comprises location of the another company, size of the another company, staff strength of the another company, and the number of subsidiaries and affiliates of the another company.

13. The system of claim 11 wherein the selected filtering criteria is any one or any combination of the following: location of the another company, size of the another company, staff strength of the another company, and the number of subsidiaries and affiliates of the another company.

14. The system of claim 11 wherein the characteristics data of each of the plurality of global benchmark company records further comprises location of the global benchmark company, size of the global benchmark company, staff strength of the global benchmark company, and the number of subsidiaries and affiliates of the global benchmark company.

15. The system of claim 11 wherein the at least one processor is further programmed to provide input templates dependent on the distinct industry type of the company.

16. The system of claims 11 wherein the operating data of the company is dependent on the distinct industry type and comprises operational costs, amount of goods produced, amount of goods exported, inventory of goods, amount of raw material used in production, and amount of labor involved in the production.

17. The system of claim 11 wherein the at least one processor is further programmed to perform a comparison between the financial data and operating data of the company and the averaged financial data and operating data of the plurality of the selected peer records on a quarter on quarter basis or on a past four quarters and up to preceding five years basis.

18. The system of claim 11 wherein the at least one processor is further programmed to perform a comparison between the financial data and operating data of the company and the financial data and operating data of the at least one selected global benchmark company record on a quarter on quarter basis or on a past four quarters and up to preceding five years basis.

19. The system of claim 11 wherein the at least one processor is further programmed to render a web portal.

20. The system of claim 11 wherein the at least one processor is further programmed to provide a message board system, wherein the message board system is configured to send to a user any one of the following: reports, targeted newsfeeds, targeted advertisements, targeted alerts and message alerts.

21. The system of claim 20 wherein the message alerts are sent by the message board system every quarter to prompt the user to update the financial data and operating data in the peer record.
